(19) United States
(12) Patent Application Publication
(10) Pub. No.: US 2011/0034280 A1
(43) Pub. Date: Feb. 10, 2011

(54) BIKE CHAIN CHECKER

(76) Inventor: Hsin-Fa Kang, Tainan City (TW)

Correspondence Address: Hsin-Fa KANG, P. O. BOX 90, Tainan City, 70499, TW

(21) Appl. No.: 12/535,690

(22) Filed: Aug. 5, 2009

(51) Int. Cl. F16H 7/14

(52) U.S. Cl. 474/116

(57) ABSTRACT

A bike chain checker includes a base, an opening formed in the bottom of the base, a leaning portion extended from one sidewall of the base toward the opening, two threaded holes bored in another sidewall for respectively engaging with a chain wheel screw and a pointer screw. The pointer is freely hung downward. A marking line is marked under one of the threaded holes. A groove is formed on the top of the base for fitting a level bar, and the level bar fixed by a screw engaged with a threaded hole bored in a sidewall of the groove. Thus, the level bar is positioned horizontally if the pointer overlaps the marking line. If the chain does not overpass the level bar when pulled up, it represents the loose allowance of the chain is acceptable. But, if passing over, the chain is too loose, needing to be adjusted.

### BACKGROUND OF THE INVENTION

1. Field of the Invention

This invention relates to a bike chain checker, particularly to one provided with a pointer freely hung on a pointer screw for a user to easily check if it absolutely overlaps a vertical marking line so as to assure a level bar positioned levelly.

The bike chain checker includes a base, an opening formed in the bottom of the base, a leaning portion horizontally extended from one sidewall of the base toward the opening, two threaded holes bored in another sidewall for respectively engaging with a chain wheel screw and a pointer screw previously extending through a pointer. The pointer is freely hung. A vertical marking line is marked under one of the threaded holes. A groove is formed in the top of the base for fitting a level bar, and the level bar fixed by a screw engaged with a threaded hole bored in a sidewall of the groove. Thus, the level bar is positioned horizontally if the pointer overlaps the vertical marking line. As the chain is pulled up and does not overpass the level bar, it represents the loose allowance of the chain is acceptable. But, if passing over, it means the chain is too loose, needing to be adjusted.

2. Description of the Prior Art Commonly, as shown in FIGS. 1 and 2, a conventional bike chain checker 1 includes a base 10, an opening 11 formed in the bottom of the base 10, a leaning portion 12 horizontally extended from the bottom of one sidewall of the base 10 toward the opening 11, a threaded hole 13 bored in another sidewall of the base 10, and a chain wheel screw 14 used to engage with the threaded hole 13. In addition, the bike chain checker 1 is also provided with a groove 15 employed for fitting a level bar 16, a threaded hole 17 bored in a sidewall defining the groove 15, and a screw 18 used for engaging with the threaded hole 17 to position stably the level bar 16. In using, the opening 11 of the base 10 is fitted with a chain wheel 2 and a chain 3 of a bike, with the leaning portion 12 resting on one side of the chain wheel 2 and the chain wheel screw 14 resting on another side, so as to keep the base 10 tightly positioned. Thus, whether the chain 3 is stretched enough or not depends merely on eye checking if the level bar 16 is positioned horizontally. However, by means of eyes only, the level of the level bar 16 cannot surely be determined, resulting in too high or too low, so that the loose allowance of the chain 3 cannot be accurately detected.

### SUMMARY OF THE INVENTION

The object of this invention is to offer a bike chain checker, which can easily and accurately position a level bar horizontally by checking if a pointer completely overlaps a vertical marking line. Then, when a chain is pulled up and does not overpass the level bar, it represents the loose allowance of the chain is acceptable. But, if passing over, it means the chain is too loose, needing to be adjusted.

The invention is characterized by having a threaded hole bored in a sidewall of a base, a vertical marking line marked under the threaded hole, and a pointer screw extended through a pointer and then engaged with the threaded hole to keep the pointer hung downward.

### BRIEF DESCRIPTION OF DRAWINGS

This invention is better understood by referring to the accompanying drawings, wherein:

FIG. 1 is a perspective view of a conventional bike chain checker;

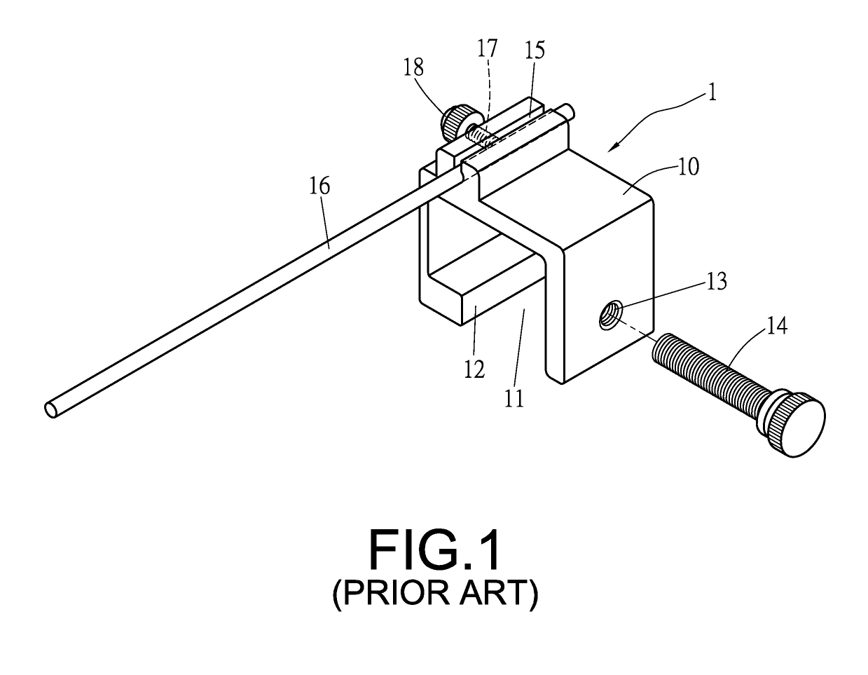

FIG. 2 is an illustrating view of the conventional bike chain checker, showing it being assembled on a chain wheel to check the loose allowance of a chain;

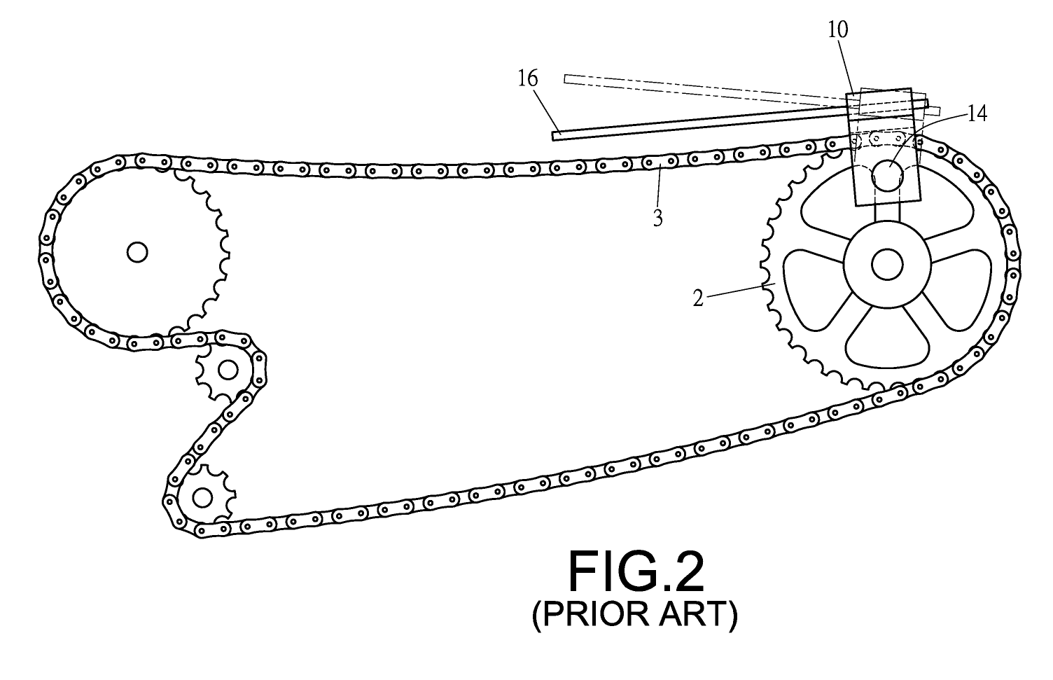

FIG. 3 is an exploded perspective view of a preferred embodiment of a bike chain checker in the present invention;

FIG. 4 is a perspective view of the preferred embodiment of a bike chain checker in the present invention;

FIG. 5 is an illustrating view of the preferred embodiment of a bike chain checker in the present invention, showing it being adjusted to keep a level bar positioned horizontally;

FIG. 6 is an illustrating view of the preferred embodiment of a bike chain checker in the present invention, showing the level bar being checked to have an acceptable loose allowance; and

FIG. 7 is an illustrating view of the preferred embodiment of a bike chain checker in the present invention, showing the level bar being checked to be too loose.

### DETAILED DESCRIPTION OF THE PREFERRED EMBODIMENT

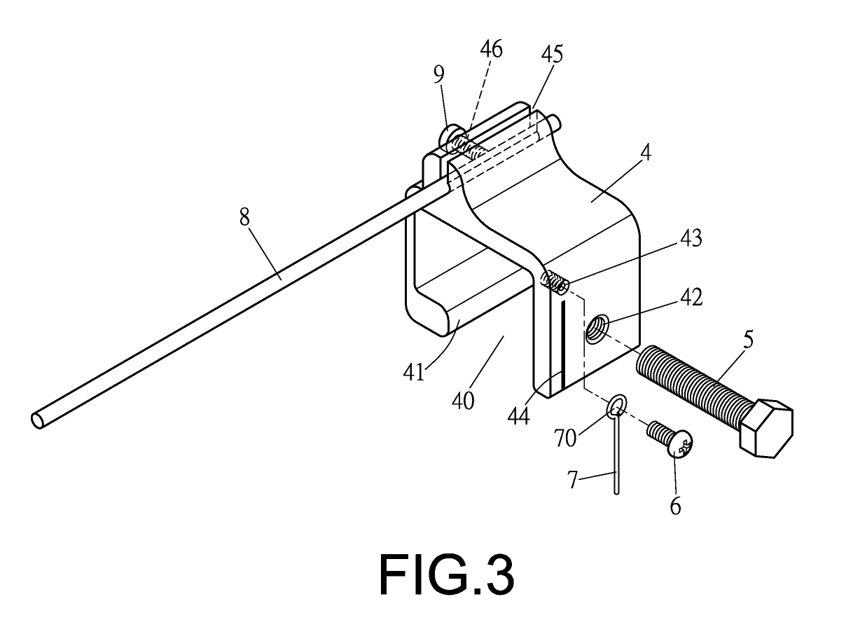

As shown in FIG. 3, the preferred embodiment of a bike chain checker in the present invention includes a base 4, an opening 40 formed in the bottom of the base 4, a leaning portion 41 horizontally extended from a bottom of one sidewall of the base 4 toward the opening 41, and a first threaded hole 42 and a second threaded hole 43 bored in another sidewall of the base 4. A chain wheel screw 5 is employed to engage with the first threaded hole 42, and a pointer screw 6 is used to extend through a through hole 70 of a pointer 7 to successively engage with the second threaded hole 43, with the pointer 7 hanging downwards. In addition, the base 4 is also provided with a vertical marking line 44 marked under the second threaded hole 43, a groove 45 formed in a top for fitting a level bar 8, a third threaded hole 46 bored in a sidewall defining the groove 45, and a level bar screw 9 used for engaging with the third threaded hole 46 to position stably the level bar 8.

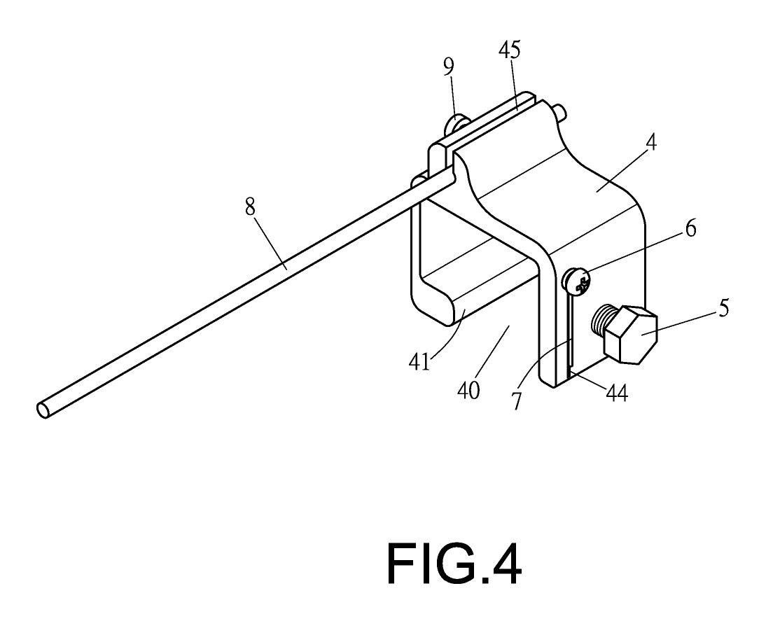

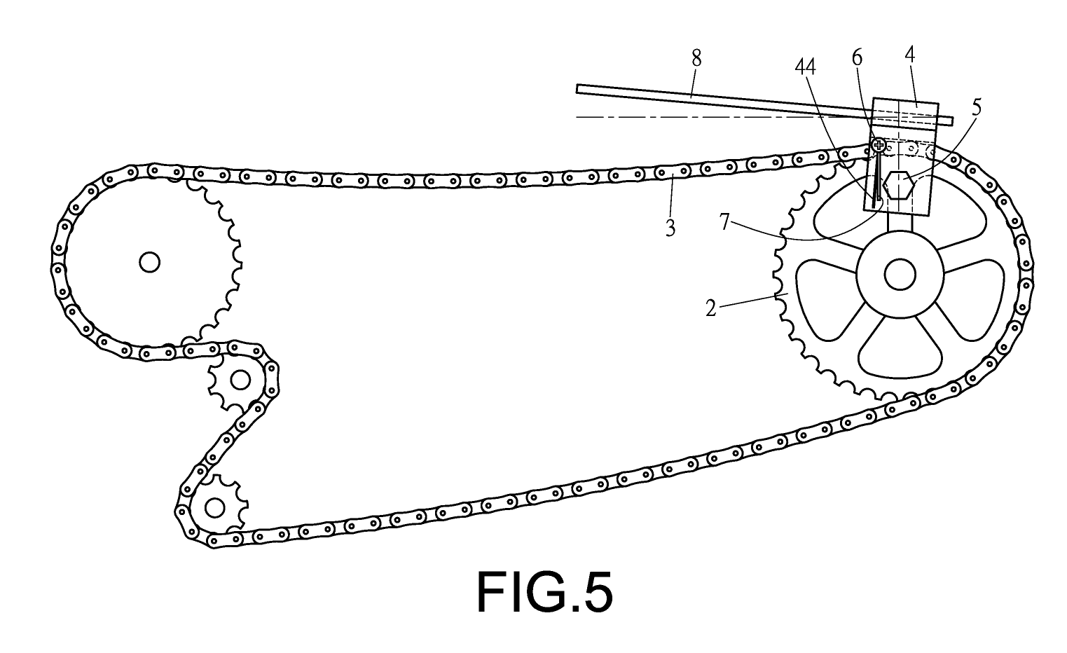

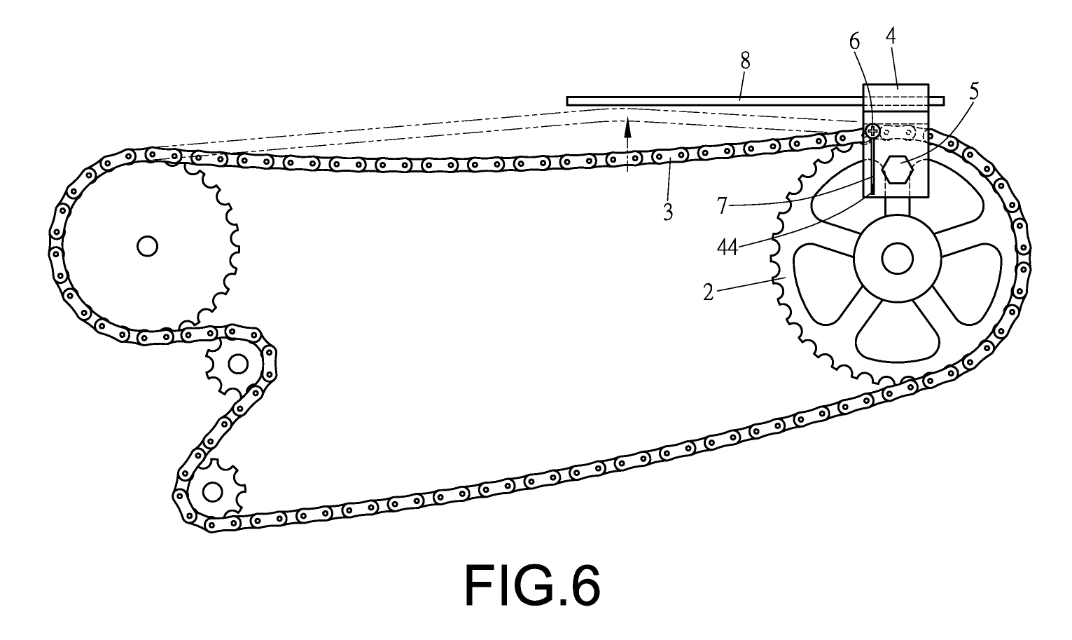

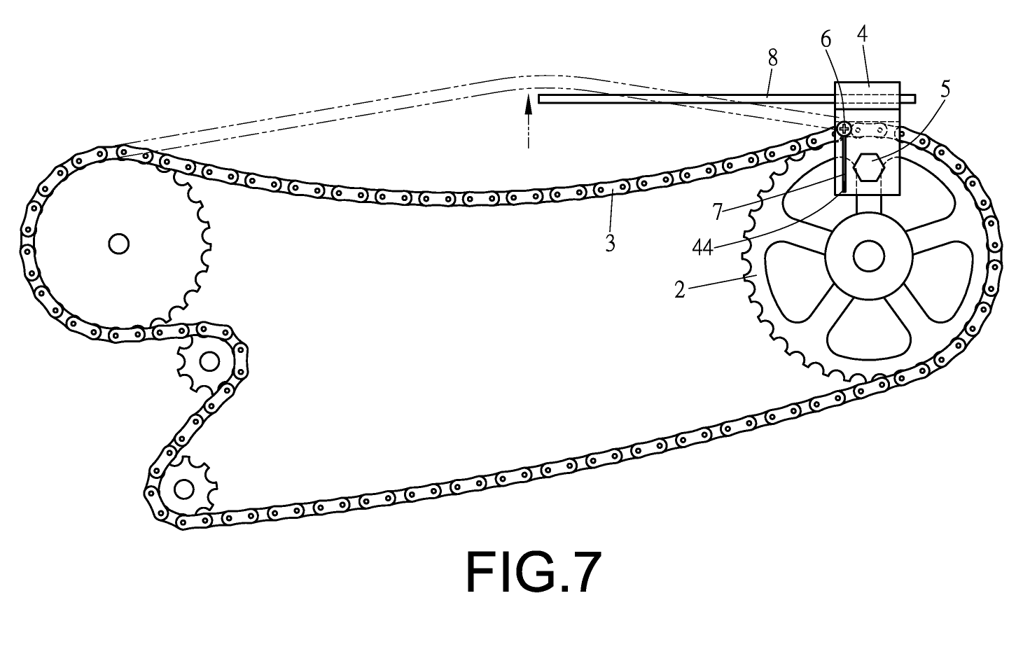

In using, as shown in FIGS. 3-7, the opening 40 of the base 4 is fitted with a chain wheel 2 and a chain 3 of a bike, with the leaning portion 41 of the base 4 resting on one side of the chain wheel 2 and the chain wheel screw 5 resting on another side, so as to position the base 4 on the chain wheel 2. By the time, it can be seen that if the pointer 7 totally overlaps the vertical marking line 44 or not. And, it represents the level bar 8 is not horizontal in case that the pointer 7 doesn't completely overlap the vertical marking line 44, as shown in FIG. 5. Then, the chain wheel screw 5 has to be loosened to adjust the base 4 until the pointer 7 exactly overlaps the vertical marking line 44. Then the chain wheel screw 5 is again tightened against the chain wheel 2. The level bar 8 is thus surely positioned horizontally. Next, as shown in FIG. 6, when the chain 3 is pulled up and does not overpass the level bar 8, it represents the loose allowance of the chain 3 is in an acceptable scope. But, if passing over the level bar 8, it means the chain 3 is too loose as shown in FIG. 7, needing to be adjusted.

While the preferred embodiment of the invention has been described above, it will be recognized and understood that various modifications may be made therein and the appended claims are intended to cover all such modifications that may fall within the spirit and scope of the invention.

What is claimed is:

1. A bike chain checker comprising a base, an opening formed in a bottom of said base, a leaning portion horizontally extended from a bottom of one sidewall of said base toward said opening, a first threaded hole bored in another sidewall of said base for engaging with a chain wheel screw, a groove formed on a top of said base for fitting a level bar therein, a third threaded hole bored in a sidewall defining said groove, a level bar screw employed to engage with said third threaded hole to keep said level bar in position stably; and
said base characterized by having a second threaded hole bored in a same sidewall of said first threaded hole, a vertical marking line marked under said second threaded hole, a pointer screw extended through a pointer and engaged with said second threaded hole to keep said pointer hung downward.

2. The bike chain checker as claimed in claim 1, wherein said pointer is provided with a through hole formed in a top.
